(19) United States
(12) Patent Application Publication
(10) Pub. No.: US 2016/0046212 A1
(43) Pub. Date: Feb. 18, 2016

(54) ADJUSTING DEVICE AND METHOD FOR PRODUCING AN ADJUSTING DEVICE

(71) Applicant: JOHNSON CONTROLS COMPONENTS GMBH & CO. KG, Kaiserslautern (DE)

(72) Inventors: Ulrich LEHMANN, Alfter (DE); Gunther HILLE, Remscheid (DE)

(21) Appl. No.: 14/780,208

(22) PCT Filed: Mar. 25, 2014
(86) PCT No.: PCT/EP2014/055943

§ 371 Date: Sep. 25, 2015

(30) Foreign Application Priority Data
Mar. 26, 2013 (DE) 10 2013 005 132.0
Jun. 4, 2013 (DE) 10 2013 009 272.8

(51) Int. Cl. B60N 2/235; E05D 11/02

(52) U.S. Cl. CPC B60N 2/2362; E05D 11/02

(57) ABSTRACT

An adjusting device, in particular for the backrest inclination adjustment of a vehicle seat, has a first fitting part (5) and a second fitting part (6). The first fitting part can be rotated in relation to the second fitting part about an axis of rotation. The adjusting device has at least one coupling device (4) for coupling the first fitting part and the second fitting part. At least a part of a surface of the coupling device (4) and/or of the first fitting part and/or of the second fitting part has structuring.

### CROSS REFERENCE TO RELATED APPLICATIONS

This application is a United States National Phase Application of International Application PCT/EP2014/055943 filed Mar. 25, 2014 and claims the benefit of priority under 35 U.S.C. §119 of German Patent Applications 10 2013 005 132.0 filed Mar. 26, 2013 and 10 2013 009 272.8 filed Jun. 4, 2013 the entire contents of which are incorporated herein by reference.

### FIELD OF THE INVENTION

The present invention is based on an adjusting device for adjusting a vehicle seat component, in particular for the backrest inclination adjustment of a vehicle seat, which has a first fitting member and a second fitting member, wherein the first fitting member can be rotated relative to the second fitting member about a rotation axis and wherein the adjusting device has at least one coupling means for coupling the first fitting member and the second fitting member.

### BACKGROUND OF THE INVENTION

Such adjusting devices are generally known, for example, from the publication DE 10 2005 054 489 A1. In this instance, conventionally a component of the adjusting device is secured to a first vehicle seat member and another component is secured to a second vehicle member which is intended to be adjusted relative to the first vehicle member. The adjusting device can be operated by means of a wheel or a detent and the two components are moved relative to each other by means of an adjustment gear of the adjusting device.

In this instance, such adjusting devices are conventionally configured in such a manner that an unintentional adjustment, for example, based on vibrations, is impossible, but an adjustment in accordance with provisions is carried out in the simplest manner possible. According to the prior art, therefore, there are provided brakes which are in contact with one or both components. In a stationary state, an unintentional adjustment is prevented by means of static friction of the brakes with the components. To this end, it is advantageous for the brake and component to be produced from the same material, since the static friction coefficient is great in this instance.

On the other hand, the sliding friction coefficient is intended to be as low as possible so that, in the event of an intentional adjustment, the brake interacts with the component in the most friction-free manner possible. To this end, there is generally applied to the brake and/or the component a coating which reduces the sliding friction. This coating generally comprises a different material and therefore reduces the static friction.

### SUMMARY OF THE INVENTION

An object of the present invention is to provide an adjusting device of the type mentioned in the introduction in which components which run on each other have a high static friction coefficient with at the same time a low sliding friction coefficient.

This object is achieved with an adjusting device, in particular for the backrest inclination adjustment of a vehicle seat, wherein the adjusting device has a first fitting member and a second fitting member, wherein the first fitting member can be rotated relative to the second fitting member about a rotation axis, wherein the adjusting device has at least one coupling means for coupling the first fitting member and the second fitting member, wherein at least a portion of a surface of the coupling means and/or the first fitting member and/or the second fitting member has a structuring, wherein the structuring is formed in a first contact region between the coupling means and the first fitting member and/or in a second contact region between the coupling means and the second fitting member, wherein the coupling means and the first fitting member and/or the second fitting member are produced from the same material.

In comparison with the prior art, the adjusting device according to the invention has the advantage that, as a result of the structuring, the friction relationships during operation of the adjusting device according to the invention are optimized. In this instance, the wording “optimize” in the context of the present invention is intended to be understood to mean that the adjusting device is constructed to be as rigid as possible with respect to unintentional adjustment, for example, as a result of vibrations, that is to say, it has a high level of static friction whilst an intentional adjustment leads to a movement, that is, in particular a rotation, which involves as little friction as possible, and therefore the sliding friction is as low as possible. This enables simpler and safer operation of the adjusting device. In comparison with an unstructured adjusting device, less lubricant, for example, oil is required. If both the coupling means and the first fitting member and/or the second fitting member have a structuring, the friction relationships can be improved even further. According to the invention, the structuring is formed in a first contact region between the coupling means and the first fitting member and/or in a second contact region between the coupling means and the second fitting member. Surfaces which contribute to the friction during a rolling operation are thereby advantageously structured. Preferably, the structuring is constructed in such a manner that the structured surface has a lower sliding friction coefficient than in the unstructured state. An adjusting device which is subject to little wear and which is simple to operate is thereby provided. Better sliding properties can be achieved, for example, by such structures produced by means of structuring acting as lubricant reservoirs, whereby better lubrication of the components which rub against each other is enabled. In particular, fluid lubricants are provided for this purpose. Furthermore, the coupling means and the first fitting member and/or the second fitting member are produced from the same material according to the invention. Preferably, the coupling means and the first fitting member and/or the second fitting member are produced from a material with a high static friction coefficient, in particular aluminum. Good static friction in the context of a high static friction coefficient is thereby produced in a particularly advantageous manner, whilst the structuring is selected in such a manner that at the same time the lowest possible sliding friction in the context of a low sliding friction coefficient occurs. An adjusting device which is subjected to particularly little wear and which is cost-effective to produce is thereby provided. An adjusting device according to the prior art and a wobble mechanism are disclosed in detail in the German-language Offenlegungsschrift DE 10 2005 054 489 A1. The disclosure of DE 10 2005 054 489 A1 is intended to be explicitly incorporated in the disclosure of the present application by reference. For example, balls or semi-spherical recesses of the surface can be produced as a structuring.

Advantageous embodiments can be taken from the description of the Figures and/or the drawings.

According to a preferred embodiment, the adjusting device has an adjustment gear for controlling the rotation of the first fitting member or the second fitting member. It is thereby advantageously possible to provide a simple actuation of the adjusting device, in particular with a transmission unit. In a particularly preferred manner, the adjustment gear is a wobble mechanism. It is thereby advantageously possible to use a known gear mechanism which has been found to be advantageous and thus to keep the production costs low. In a quite particularly preferred manner, the coupling means are configured in such a manner that the rotation is blocked up to a specific torque by means of static friction.

According to a preferred embodiment, a lubricant is provided in at least one portion of the structures produced by the structuring. In a particularly preferred manner, the lubricant is a fluid lubricant, in particular a highly viscous lubricant, a lubricating grease and/or a gaseous lubricant. In a quite particularly preferred manner, the lubricant is a lubricant oil. The person skilled in the art understands that it is possible to use as lubricants those in accordance with the so-called API classification API GL-1 to API GL-5. It is thereby advantageously possible, without using bonded coatings or solid lubricants, whose introduction or application is generally complex and time-consuming, to provide an adjusting device having low sliding friction coefficients and at the same time high static friction coefficients.

Another aspect of subject-matter of the present invention is a method for producing an adjusting device, preferably for producing an adjusting device according to the invention, wherein a coupling means and a first fitting member and a second fitting member of the adjusting device are produced in a first method step, wherein the coupling means and the first fitting member and/or the second fitting member are produced from the same material in the first method step, wherein at least a portion of a surface of the coupling means and/or the first fitting member and/or the second fitting member is structured in a second method step, wherein the structuring is carried out in a first contact region between the coupling means and the first fitting member and/or in a second contact region between the coupling means and the second fitting member, wherein the first fitting member and the second fitting member and the coupling means are assembled to form an adjusting device in a third step.

It is thereby advantageously possible to produce a friction-optimized adjusting device in a simple and rapid manner. The structuring requires less time expenditure than a coating and advantageously requires no subsequent processing. Lubricant reservoirs can consequently be provided in a geometrically precise manner. According to the invention, the structuring is carried out in a first contact region between the coupling means and the first fitting member and/or in a second contact region between the coupling means and the second fitting member. In particular, surfaces of the coupling means and/or the first fitting member and/or the second fitting member are thereby advantageously structured, which surfaces are provided for friction.

According to a preferred embodiment, the surface material with the static friction coefficient remaining the same has a lower sliding friction coefficient than in the unstructured state. It is thereby advantageously possible to provide an adjusting device which is subjected to little wear and which is simple to operate.

According to a preferred embodiment, in the first method step the coupling means and the first fitting member and/or the second fitting member are produced from the same material. In a particularly advantageous manner, good static friction in the context of a high static friction coefficient is thereby possible.

According to a preferred embodiment, in the second step for structuring the surfaces, a direct laser interference structuring is used, wherein in a first part-step two coherent and collimated laser beams, in particular of the same laser source, are superimposed on the surfaces to be structured in the region of a structuring zone, wherein the structuring zone is produced in a second part-step by moving the laser beams and/or the surface to be structured. It is thereby possible in a particularly advantageous manner to use a particularly simple, flexible and cost-effective method. In contrast to conventional coating methods a direct laser interference structuring does not require any pressure reduction or a special surrounding medium so that the method is significantly more cost-effective and rapid than a conventional coating method. Furthermore, both the size of the surface to be structured and the structure size with the direct laser interference structuring can be adjusted in a flexible manner within specific limits so that the method can advantageously be used on extremely different components and for extremely different structures.

According to a preferred embodiment, the structuring zone, projected onto the surfaces to be structured, is in the order of magnitude of from 1 mm2 to 10,000 mm2, in particular in the order of magnitude of 10 mm2 or 100 mm2 or 1000 mm2. A flexible use on different surface sizes is thereby advantageously possible.

According to a preferred embodiment, the structuring is carried out at a speed between 1 cm2/s and 100 cm2/s. As a result of the high process speeds, the overall process time of the production of an adjusting device according to the invention is advantageously reduced. Furthermore, depending on the complexity and/or size of the structures to be applied, an adaptation of the process speed is advantageously possible.

According to a preferred embodiment, the structuring is carried out in an order of magnitude of from 1 nm to 100 μm. This is intended to be understood to mean that the structures which are produced and/or which are intended to be applied have an order of magnitude of from 1 nm to 100 μm. It is thereby advantageously possible to apply a large number of very small structures in a method step, whereby, on the one hand, the friction properties of the surface can be controlled in a very precise manner and, on the other hand, the process speed is significantly increased.

According to a preferred embodiment, in the second and/or third step, a lubricant is introduced into at least a portion of the structured surface. In a particularly preferred manner, the lubricant is introduced into recesses of the structuring. In a quite particularly preferred manner, the lubricant is arranged on the surface in the region of the structuring. The person skilled in the art understands that, in the assembled state or during operation, the lubricant is automatically distributed by the contact of the surfaces of the coupling means and the first fitting member and/or the second fitting member.

Another aspect of subject-matter of the present invention is a vehicle seat having an adjusting device according to the invention. It is thereby advantageously possible to provide a vehicle seat having an adjusting device which is particularly simple to operate.

Further details, features and advantages of the invention will be appreciated from the drawings and from the following description of preferred embodiments with reference to the drawings. The drawings in this instance illustrate purely exemplary embodiments of the invention which do not limit the significant notion of the invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic diagram according to an exemplary first embodiment of the present invention;

FIG. 2 is a schematic diagram of an exemplary second embodiment of the present invention;

FIG. 3 is a schematic detailed view of an exemplary third embodiment of the present invention;

FIG. 4 is a schematic exploded illustration of the exemplary third embodiment of the present invention.

### DESCRIPTION OF THE PREFERRED EMBODIMENTS

In the different Figures, components which are the same are always provided with the same reference numerals and are therefore generally also only cited or mentioned once.

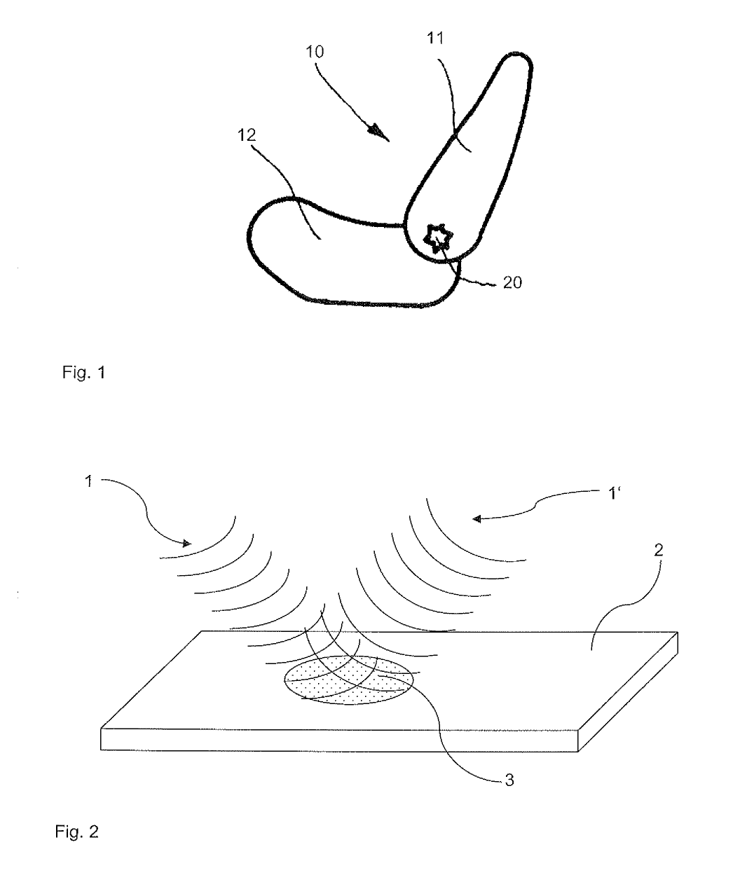

FIG. 1 is a schematic diagram according to an exemplary embodiment of the present invention. A vehicle seat 10 has a seat member 12 and a backrest 11 which is rotatably connected to the seat member 12. The rotation of the backrest 11 about the seat member 12 is brought about by means of an adjusting device 20. The adjusting device 20 in this instance has a schematically illustrated hand wheel which, in the event of rotation by a user, moves the backrest 11 in the direction of the seat member 12 or in the opposite direction about the rotation axis which is predetermined by the adjusting device 20. It is also conceivable for there to be a plurality of rotation axes or for an actuation means such as the hand wheel to be fitted at another location. Alternatively, the adjusting device 20 can be operated by means of a detent instead of by means of a hand wheel.

FIG. 2 is a schematic diagram of an exemplary embodiment of the present invention. A surface 2, which is provided for contact with an additional surface which is not illustrated, is intended to be structured. The surface 2 may in this instance be a surface 2 of a coupling means 4 or a surface 2 of a first fitting member 5 or second fitting member 6 or a surface 2 of an additional component of the adjusting device, which component is provided for rolling. From a laser which is not illustrated, for example, a Q-switched laser, two collimated and coherent laser beams 1, 1′ are decoupled, for example, by means of a beam splitter, and, in the region of the surface 2 to be structured, caused to overlap. The first laser beam 1 and the second laser beam 1′ are in this instance illustrated purely schematically for the sake of simplicity. In the overlap region, the first laser beam 1 and the second laser beam 1′ interfere in such a manner that the surface 2 is locally structured in accordance with the adjustable interference pattern. In this instance, the extent of the structuring zone moves in the order of magnitude of from a few square millimeters up to a few square centimeters. The precise size may in this instance be adjusted by means of the collimation of the laser beams 1, 1′. The depth to which the material of the surface 2 is structured is inter alia dependent on both the material and the laser power used and can accordingly be adjusted by means of at least the two parameters mentioned. For example, structure heights of fractions of micrometers can be produced, in particular structure heights in the order of magnitude of 100 nm or 500 nm or 1 μm can be produced. The structures may have a variety of shapes. Since the structures are produced by means of a local melting of the surface material, together with an at least partial evaporation of the material, the structural form can be controlled inter alia by means of the process speed and the cooling rate. It is possible to consider, for example, a large number of regular recesses or balls as structures. These may, for example, be used as microscopic lubricant reservoirs, for example, for fluid lubricants. The direct laser beam interference structuring consequently produces microscopic or even nanoscopic structures in a macroscopic surface region. In this instance, complex structures are also produced in a single process step.

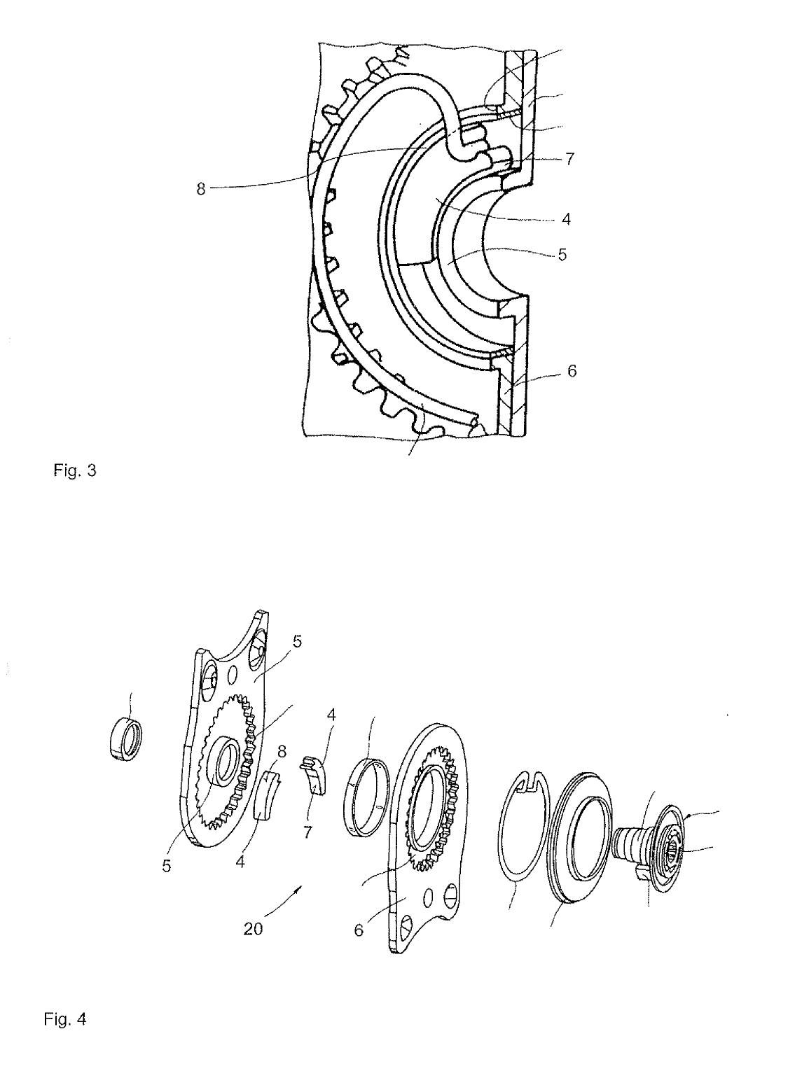

FIG. 3 is a detailed schematic illustration of an exemplary third embodiment of the present invention. A perspective detailed view as a sectioned illustration of an adjusting device 20 according to the invention is shown. A first fitting member 5 is rotated relative to a second fitting member 6. In order to prevent unintentional adjustment, the adjusting device 20 has one or more coupling means 4 which cooperate in a first contact region having an inner side 7 in a frictional manner with the first fitting member 5 and in a second contact region having an outer side 8 with the second fitting member 6 and thus couple the first fitting member 5 to the second fitting member 6. In the stationary state, it is impossible to adjust as a result of the static friction of the inner side 7 with the first fitting member 5 or the outer side 8 with the second fitting member 6. In order to ensure the best possible static friction, coupling means 4 and a first fitting member 5 and a second fitting member 6 are produced from the same material, in this instance, for example, steel. An intentional adjustment leads to a movement of the fitting members 5, 6 relative to the coupling means 4, whereby the static friction is converted into a sliding friction. This sliding friction is intended to be as low as possible so that a user has to use only small forces for an adjustment and the heat development and the wear of the device are reduced. To this end, the inner side 7 and the outer side 8 of the coupling means 4 are structured in accordance with the method explained in FIG. 2. Consequently, a low sliding friction is possible with at the same time high static friction (as a result of the material pairing steel/steel).

FIG. 4 is a schematic exploded view of the exemplary third embodiment of the present invention. The embodiment corresponds to the embodiment which is illustrated in FIG. 3. The first fitting member 5 and the second fitting member 6 of an adjusting device 20 are illustrated here. According to the embodiment illustrated, the adjusting device 20 has two coupling means 4.

While specific embodiments of the invention have been shown and described in detail to illustrate the application of the principles of the invention, it will be understood that the invention may be embodied otherwise without departing from such principles.

1. An adjusting device for the backrest inclination adjustment of a vehicle seat, the adjusting device comprising:
a first fitting member;
a second fitting member, wherein the first fitting member can be rotated relative to the second fitting member about a rotation axis; and
at least one coupling means for coupling the first fitting member and the second fitting member, wherein at least a portion of a surface of at least one of the coupling means and the first fitting member and the second fitting member has a structuring formed in at least one of a first contact region between the coupling means and the first fitting member and in a second contact region between the coupling means and the second fitting member, wherein at least one of the coupling means and the first fitting member and the coupling means and the second fitting member are produced from the same material.

2. The adjusting device as claimed in claim 1, wherein the structuring is constructed in such a manner that the structured surface has a lower sliding friction coefficient than in the unstructured state.

3. The adjusting device as claimed in claim 1, wherein a lubricant is provided in at least one portion of structures produced by the structuring.

4. The adjusting device as claimed in claim 1, wherein the structuring is produced as a large number of semi-spherical recesses of the surface.

5. The adjusting device as claimed in claim 1, wherein the structuring is constructed in such a manner that the structures produced act as lubricant reservoirs.

6. The adjusting device as claimed in claim 1, wherein the structures produced have an order of magnitude of from 1 nm to 100 μm.

7. (canceled)

8. A method for producing an adjusting device, the method comprising the steps of:
producing a coupling means, a first fitting member and a second fitting member of the adjusting device, wherein at least one of the coupling means and the first fitting member and the second fitting member are produced from the same material; and
structuring at least a portion of a surface of at least one of the coupling means and the first fitting member and the second fitting member, wherein the structuring is carried out at least one of in a first contact region between the coupling means and the first fitting member and in a second contact region between the coupling means and the second fitting member; and
assembling the first fitting member, the second fitting member and the coupling means to form the adjusting device.

9. The method as claimed in claim 8, wherein a lubricant is introduced into at least a portion of the structured surface during at least one of the steps of structuring assembling.

10. The method as claimed in claim 8, wherein the step of structuring comprises using a direct laser interference structuring with two coherent and collimated laser beams of the same laser source superimposed on the surfaces to be structured in the region of a structuring zone, and the structuring zone is produced by moving the laser beams relative to the surface to be structured.

11. The method as claimed in claim 9, wherein the step of structuring comprises using a direct laser interference structuring with two coherent and collimated laser beams of the same laser source superimposed on the surfaces to be structured in the region of a structuring zone, and the structuring zone is produced by moving the laser beams relative to the surface to be structured.

12. A vehicle seat comprising:
a seat member;
a backrest; and
an adjusting device connected to the seat member and the backrest for the backrest inclination adjustment, the adjusting device comprising:
a first fitting member;
a second fitting member, wherein the first fitting member can be rotated relative to the second fitting member about a rotation axis; and
at least one coupling means for coupling the first fitting member and the second fitting member, wherein at least a portion of a surface of at least one of the coupling means and the first fitting member and the second fitting member has a structuring formed in at least one of a first contact region between the coupling means and the first fitting member and in a second contact region between the coupling means and the second fitting member, wherein at least one of the coupling means and the first fitting member and the coupling means and the second fitting member are produced from the same material.

13. The adjusting device as claimed in claim 12, wherein the structuring is constructed in such a manner that the structured surface has a lower sliding friction coefficient than in the unstructured state.

14. The adjusting device as claimed in claim 12, wherein a lubricant is provided in at least one portion of the structures produced by the structuring.

15. The adjusting device as claimed in claim 12, wherein the structuring is produced as a large number of semi-spherical recesses of the surface.

16. The adjusting device as claimed in claim 12, wherein the structuring is constructed in such a manner that the structures produced act as lubricant reservoirs.

17. The adjusting device as claimed in claim 12, wherein the structures produced have an order of magnitude of from 1 nm to 100 μm.
